(19) United States
(12) Patent Application Publication
(10) Pub. No.: US 2015/0264175 A1
(43) Pub. Date: Sep. 17, 2015

(54) INTERACTIVE VOICE RESPONSE SYSTEM SPEECH RECOGNITION PROXY

(71) Applicant: LENOVO (Singapore) PTE, LTD., New Tech Park (SG)

(72) Inventors: Antonio Bumarch, III, Cary, NC (US); Neal Robert Caliendo, JR., Raleigh, NC (US); Russell Speight VanBlon, Raleigh, NC (US); Arnold S. Weksler, Raleigh, NC (US)

(73) Assignee: LENOVO (Singapore) PTE, LTD., New Tech Park (SG)

(21) Appl. No.: 14/213,977

(22) Filed: Mar. 14, 2014

(51) Int. Cl. H04M 3/493; G10L 15/08

(52) U.S. Cl. CPC H04M 3/4936; G10L 15/08

(57) ABSTRACT

For an IVR system speech recognition proxy, code may determine that a communication device is in communication with an IVR system that does not support IVR speech recognition. In addition, the code may convert a specified spoken alphanumeric value into a telephonic keypad tone value in response to determining that the communication device is in communication with the IVR system that does not support IVR speech recognition.

### FIELD

The subject matter disclosed herein relates to an interactive voice response (IVR) system and more particularly relates to an IVR system speech recognition proxy.

### BACKGROUND

### Description of the Related Art

IVR systems are used to automate the receiving, routing, and placing of telephone calls. IVR systems often require a telephonic keypad tone value response.

### BRIEF SUMMARY

An apparatus for an IVR system speech recognition proxy is disclosed. The apparatus includes a communication device, a processor, and a memory that stores code executable by the processor. The code determines that the communication device is in communication with an IVR system that does not support IVR speech recognition. In addition, the code converts a specified spoken alphanumeric value into a telephonic keypad tone value in response to determining that the communication device is in communication with the IVR system that does not support IVR speech recognition. A method and computer program product also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a speech recognition proxy system;

FIG. 1B is a drawing illustrating embodiments of communication devices;

FIG. 2 is a schematic block diagram illustrating one embodiment of IVR data;

FIG. 3 is a schematic block diagram illustrating one embodiment of a communication device;

FIG. 4 is a schematic flow chart diagram illustrating one embodiment of a speech recognition enablement method;

FIG. 5 is a schematic flow chart diagram illustrating one alternate embodiment of a speech recognition enablement method; and

FIG. 6 is a schematic flow chart diagram illustrating one embodiment of a spoken alphanumeric value conversion method; and

FIG. 7 is a schematic flow chart diagram illustrating one alternate embodiment of a spoken alphanumeric value conversion method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages, including an object oriented programming language such as Java, Smalltalk, C++ or the like and conventional procedural programming languages, such as the “C” programming language or similar programming languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

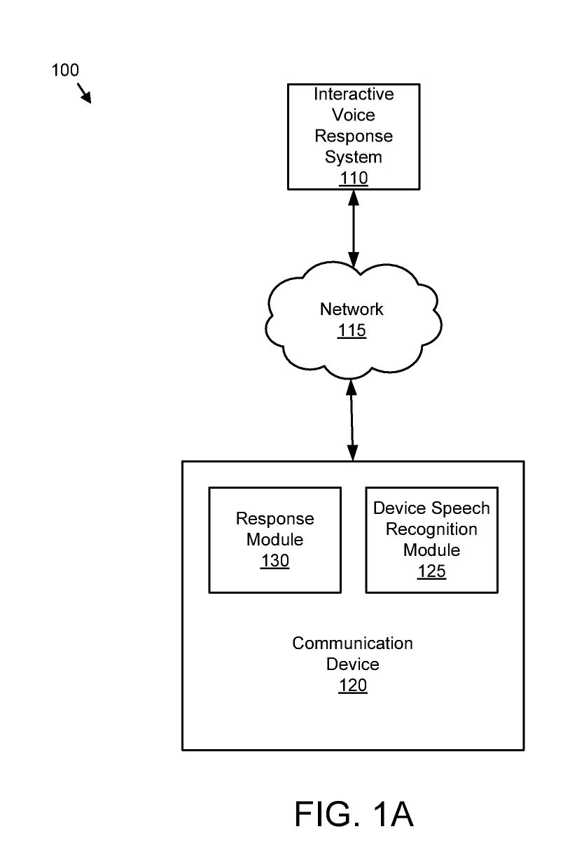

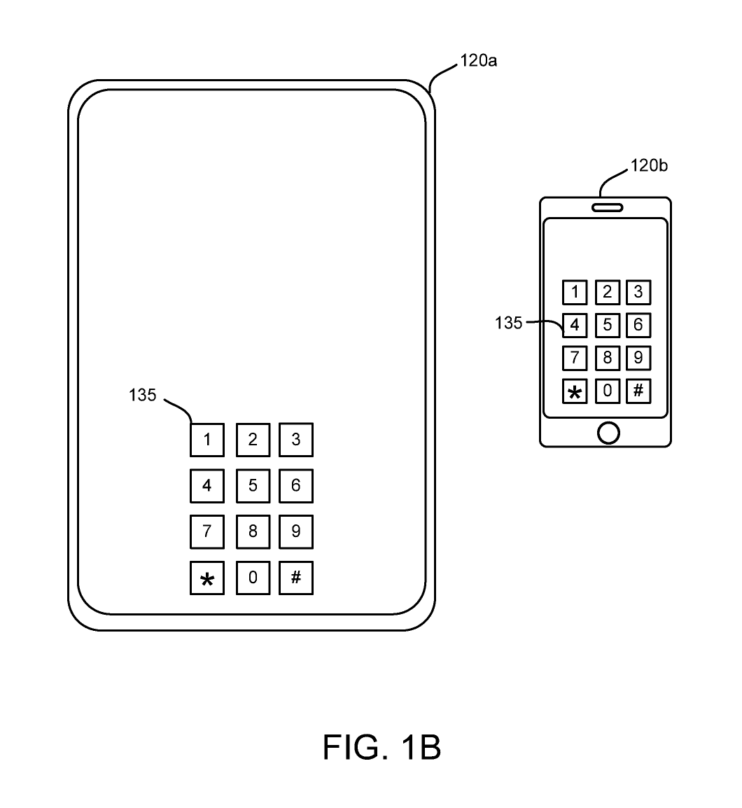

FIG. 1A is a schematic block diagram illustrating one embodiment of a speech recognition proxy system 100. The system 100 includes an IVR system 110, a network 115, and a communication device 120. The IVR system 110 may provide automated telephonic communication over the network 115 with the communication device 120. For example, the communication device 120 may place a telephone call over the network 115 that is received by the IVR system 110. Alternatively, the IVR system 110 may place an outbound call over the network 115 to the communication device 120.

The network 115 may be the Internet, a mobile telephone network, a landline telephone network, a wide area network, a local area network, a Wi-Fi network, or combinations thereof. The communication device 120 may be a mobile telephone, a tablet computer, laptop computer, a computer workstation, a server, and the like.

The IVR system 110 may provide voice prompts that direct the user in navigating a menu structure. In one embodiment, the menu structure is a hierarchical menu structure. The user may make selections with a telephonic keypad to select menu options, enter information, and navigate the menu structure. Some IVR systems 110 may also accept voice input from the user and use IVR speech recognition to select the menu options, enter information, and navigate the menu structure.

Unfortunately, not all IVR systems 110 support IVR speech recognition and accept voice input. In addition, it is often inconvenient and/or dangerous for a user to make selections with the telephonic keypad. For example, the user may be talking on a mobile telephone while the mobile telephone is in a pocket. Alternatively, the user may be operating a vehicle, making it dangerous to select options with the telephonic keypad.

The embodiments described herein determine that the communication device 120 is in communication with an IVR system 110 that does not support IVR speech recognition and so cannot accept voice inputs from the user. In addition, the embodiments convert a specified spoken alphanumeric value into a telephonic keypad tone value in response to determining that the communication device 120 is in communication with the IVR system 110 that does not support speech recognition as will be described hereafter.

In one embodiment, the communication device 120 includes a response module 130 and a device speech recognition module 125. The response module 130 and the device speech recognition module 125 may be embodied in a memory that stores code that is executable by a processor.

The response module 130 may determine that the communication device 120 is in communication with an IVR system 110 that does not support IVR speech recognition. With the information about whether the IVR system 110 does or does not support IVR speech recognition, the device recognition module 125 can determine whether to provide a speech recognition proxy that converts one or more specified spoken alphanumeric values into telephonic keypad tone values.

For example, the user may employ the communication device 120 to communicate with the IVR system 110. The response module 130 may determine that the IVR system 110 does not support IVR speech recognition. As a result, the IVR system 110 prompts the user to select menu options, enter information, and otherwise navigate the menu structure must be responded to with telephonic keypad tone values.

The device speech recognition module 125 may convert one or more specified spoken alphanumeric values into the telephonic keypad tone values that correspond to the one or more spoken alphanumeric values. As a result, the user may navigate the IVR system 110 without using the telephonic keypad of the communication device 120 as will be described hereafter.

FIG. 1B is a drawing illustrating embodiments of communication devices 120. A tablet computer 120a and a mobile telephone 120b are depicted. The communication devices 120 may display telephonic keypads 135. The telephonic keypads 135 may generate telephonic keypad tone values that are communicated over the network 115 to the IVR system 110. The telephonic keypad tone values may be dual-tone multi-frequency signals.

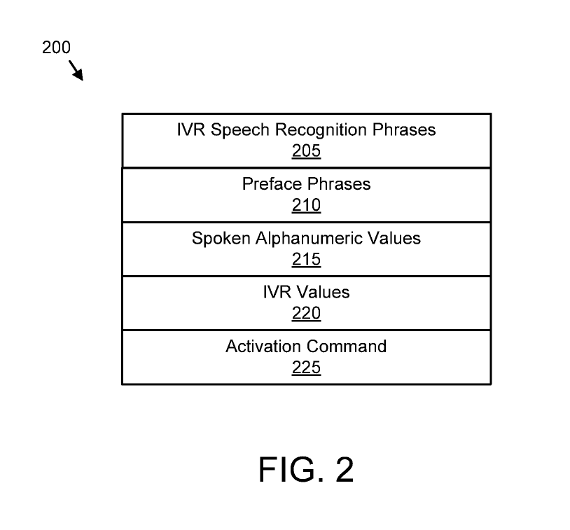

FIG. 2 is a schematic block diagram illustrating one embodiment of IVR data 200. The IVR data 200 may be stored in a memory of the communication device 120. The IVR data 200 may be organized as a data structure. In the depicted embodiment, the IVR data 200 includes IVR speech recognition phrases 205, preface phrases 210, spoken alphanumeric values 215, IVR values 220, and activation command 225.

The IVR speech recognition phrases 205 may include one or more phrases. The IVR speech recognition phrases 205 may be stored as text, phonemes, frequency histograms, or combinations thereof. In addition, each IVR speech recognition phrase 205 may include an IVR speech recognition value that indicates whether or not the IVR speech recognition phrase 205 is associated with IVR speech recognition. Table 1 illustrates one embodiment of IVR speech recognition phrases 205.

TABLE 1

| IVR Speech Recognition Phrase | IVR Speech Recognition Value |
|---|---|
| “Press <numeral>” “Press one” | No IVR Speech Recognition |
| “Press or say <numeral>” “Press or say | IVR Speech Recognition |
| one” | |
| “Press” AND “Say” within 0.5-1.5 | IVR Speech Recognition |
| seconds | |
| “Say” | IVR Speech Recognition |

For example, the response module 130 may determine that the communication device 120 is in communication with an IVR system 110 that does not support IVR speech recognition in response to detecting the phrase “Press one.”

The spoken alphanumeric values 215 may be alphanumeric values that can be communicated through the telephonic keypad 135. In one embodiment, the spoken alphanumeric values 215 include the numerals 0-9, a star (*,) and a pound sign (#). In addition, the spoken alphanumeric values 215 may include letters of the alphabet. Table 2 shows exemplary spoken alphanumeric values 215 and corresponding telephonic keypad tone values. For simplicity, only representative spoken alphanumeric values 215 are shown.

TABLE 2

| Spoken | Telephonic |
|---|---|
| Alphanumeric | Keypad |
| Value | Tone Value |
| Star | * |
| Pound Sign | # |
| 0 | 0 |
| 1 | 1 |
| 2 | 2 |
| 3 | 3 |
| A | 2 |
| B | 2 2 |
| C | 2 2 2 |

For example, to represent “C” the telephonic keypad tone value for “2” may be repeated 3 times.

The preface phases 210 may include one or more phrases that precede a spoken alphanumeric value 215. The preface phases 210 may be stored as text, phonemes, frequency histograms, or combinations thereof. In one embodiment, the device speech recognition module 125 may convert a specified spoken alphanumeric value 215 into a telephonic keypad tone value if the spoken alphanumeric value 215 is preceded by a preface phrase 210. The preface phrases 210 may be predefined for the communication device 120. Alternatively, one or more preface phrases 210 may be specified by the user. Table 3 illustrates exemplary preface phrases 210 that are in no way limiting.

TABLE 3
Preface Phrase

“Press”
“Keypad”
“Press Key”
“Enter Key”

For example, the user may direct the device speech recognition module 125 to communicate the spoken alphanumeric value 215 “B” as a telephonic keypad tone value by saying a preface phrase 210 followed by the spoken alphanumeric value 215, such as “Press B.” In response, the device speech recognition module 125 may communicate the telephonic keypad tone values “2” and “2” over the network 115 to the IVR system 110.

The IVR values 220 may be used to recognize an IVR system 110. In one embodiment, the IVR values 220 include a voice print of one or more IVR system voices. The response module 130 may recognize an IVR system 110 in response to recognizing a known IVR system voice using the voice print. Alternatively, the IVR values 220 may include one or more phone numbers for known IVR systems 110. The response module 130 may recognize the IVR system 110 if the communication device 120 is calling a known IVR system phone number. In one embodiment, the user may direct that a phone number is stored to the IVR values 220.

The activation command 225 may specify one or more gesture commands, spoken commands, touch commands, and/or motion commands. For example, the phrase “start speech recognition” may be a spoken command. Similarly, a tap to a display of a mobile telephone communication device 120 may be an activation command 225. The activation command 225 may be predetermined for the communication device 120. Alternatively, the activation command 225 may be specified by the user. The activation commands 225 may be used to determine that the IVR system 110 does not support IVR speech recognition. Alternatively the activation commands 225 may be used to enable speech conversion as will be described hereafter.

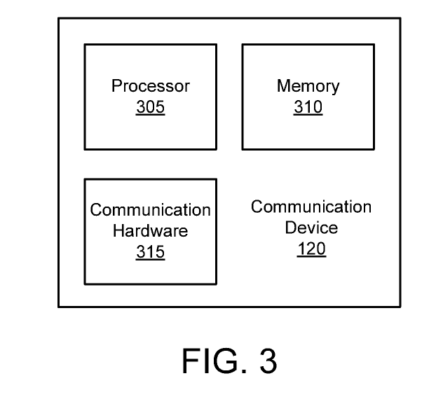

FIG. 3 is a schematic block diagram illustrating one embodiment of a communication device 120. In the depicted embodiment, the communication device 120 includes a processor 305, a memory 310, and communication hardware 315. The memory 310 may comprise a semiconductor storage device, a hard disk drive, an optical storage device, a micromechanical storage device, or combinations thereof. The memory 310 may store code. The processor 305 may execute the code. The communication hardware 315 may provide communications between the communication device 120 and the network 115.

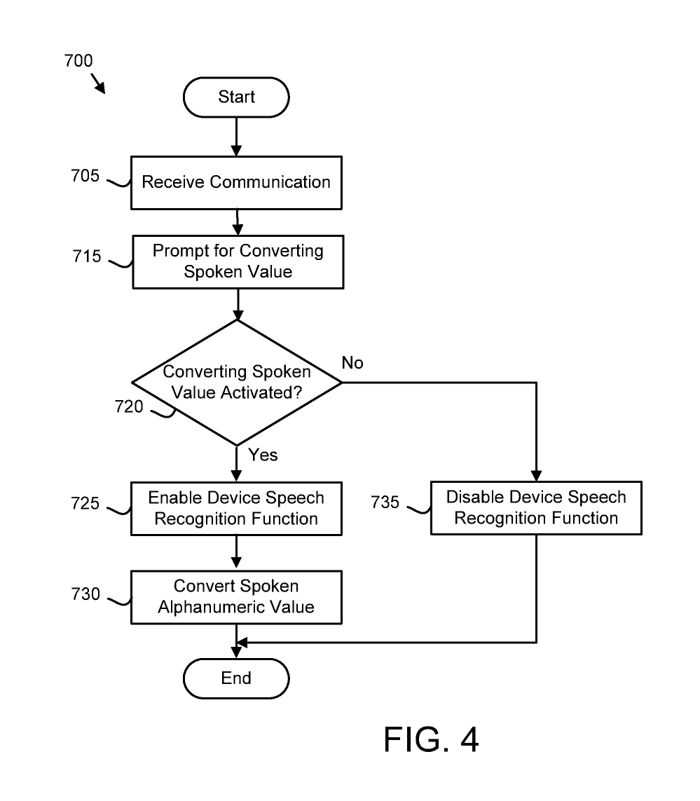

FIG. 4 is a schematic flow chart diagram illustrating one embodiment of a speech recognition enablement method 700. The method 700 may perform the functions of the communication device 120. In particular, the method 700 may enable conversion of a specified spoken alphanumeric value 215 into a telephonic keypad tone value at the communication device 120. The method 700 may be performed by the processor 305. Alternatively, the method 700 may be performed by computer readable storage medium such as the memory 310. The computer readable storage media may store code that is executed by the processor 305 to perform the method 500. The computer readable storage medium may be embodied in a program product.

The method 700 starts, and in one embodiment the communication device 120 receives 705 a communication. The communication may be from the IVR system 110. The communication may be automated speech communicated over the network 115. The automated speech may direct the user to navigate a menu structure.

The device speech recognition module 125 may prompt 715 for converting the specified spoken alphanumeric value. Prompting 715 for converting the specified spoken alphanumeric value 215 may comprise displaying a prompt asking the user if the specified spoken alphanumeric values 215 should be converted into telephonic keypad tone values. For example, the prompt “Convert Keypad Values?” may be displayed. Alternatively, the prompt “Activate Speech Conversion?” may be displayed.

The device speech recognition module 125 may determine 720 if converting the specified spoken alphanumeric value 215 is activated. In one embodiment, the device speech recognition module 125 determines 720 that converting the specified spoken alphanumeric value 215 is activated if the user responds with an affirmative indication in response to the prompt 715 for converting the specified spoken alphanumeric value 215. For example, the user may respond with one or more activation commands 225. For example, a microphone of the communication device 120 may detect a spoken activation command 225 and determine 720 that converting the specified spoken alphanumeric value 215 is activated.

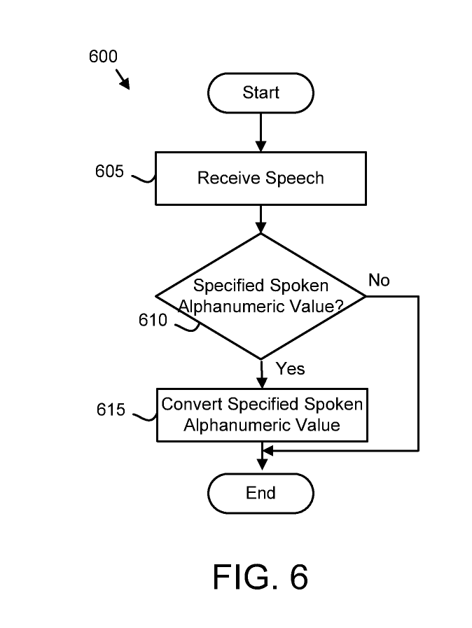

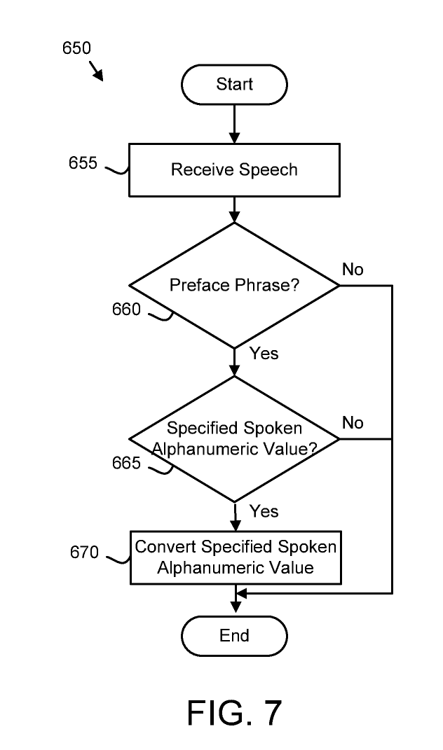

If converting the specified spoken alphanumeric value 215 is not activated, the device speech recognition module 125 may disable 735 the device speech recognition function and the method 700 ends. As a result, no spoken alphanumeric values 215 are converted into telephonic keypad tone values. If converting the specified spoken alphanumeric value 215 is activated, the device speech recognition module 125 may enable 725 the device speech recognition function. As a result, the device speech recognition module 125 may convert 730 the spoken alphanumeric values 215 into telephonic keypad tone values as will be described in FIGS. 6-7 and the method 700 ends.

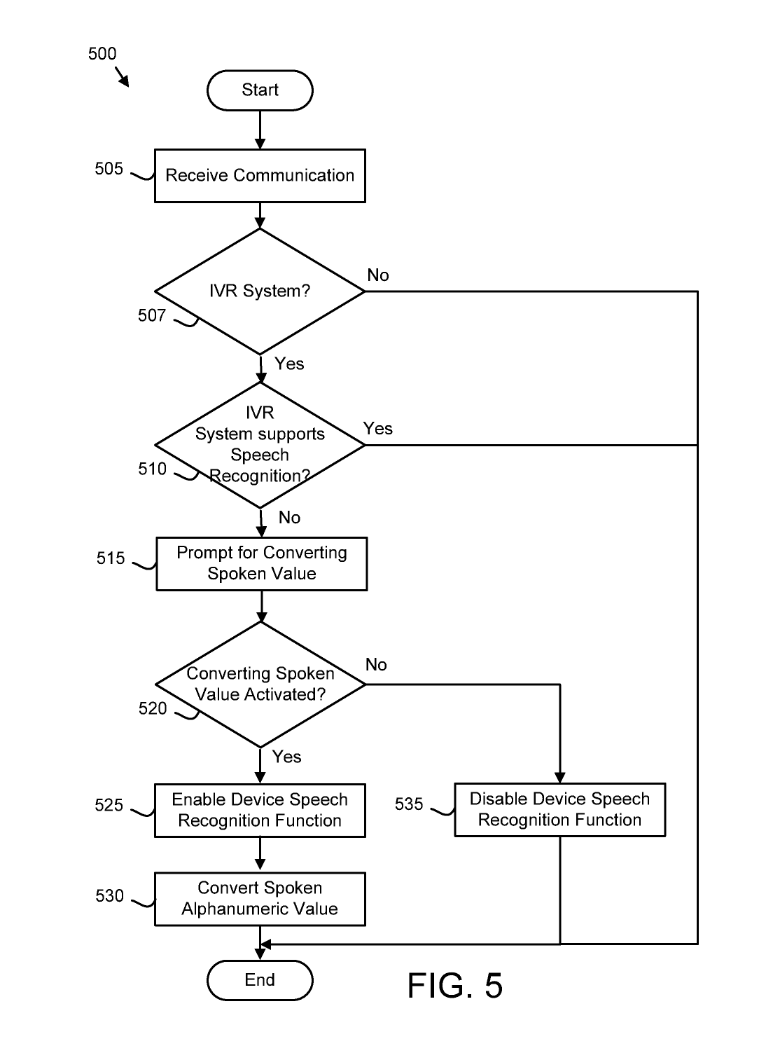

FIG. 5 is a schematic flow chart diagram illustrating one alternate embodiment of a speech recognition enablement method 500. The method 500 may perform the functions of the communication device 120. In particular, the method 500 may detect an IVR system 110 without speech recognition and may enable conversion of a specified spoken alphanumeric value 215 into a telephonic keypad tone value at the communication device 120. The method 500 may be performed by the processor 305. Alternatively, the method 500 may be performed by computer readable storage medium such as the memory 310. The computer readable storage media may store code that is executed by the processor 305 to perform the method 500. The computer readable storage medium may be embodied in a program product.

The method 500 starts, and in one embodiment the communication device 120 receives 505 a communication from the IVR system 110. The communication may be automated speech communicated over the network 115. The automated speech may direct the user to navigate a menu structure.

The response module 130 may determine 507 if the communication is from the IVR system 110. In one embodiment, the response module 130 determines 507 that the communication is from the IVR system 110 in response to detecting one or more IVR values 220. For example, the response module 130 may detect an IVR system voice and identify the communication as from the IVR system 110. Alternatively, the response module 130 may detect an IVR system phone number and identify the communication as from the IVR system 110. If the communication is not from an IVR system 110, the method 500 ends.

If the communication is from the IVR system 110, the response module 130 may determine 510 if the IVR system 110 supports IVR speech recognition. The response module 130 may determine 510 whether or not the IVR system 110 supports IVR speech recognition by detecting one or more IVR speech recognition phrases 205 and consulting the associated IVR speech recognition values. In one embodiment, if the associated IVR speech recognition values indicate support for IVR speech recognition, the response module 130 may determine 510 that the IVR system 110 does support IVR speech recognition. Alternatively, if the associated IVR speech recognition values indicate no support for IVR speech recognition, the response module 130 may determine 510 that the IVR system 110 does not support IVR speech recognition.

If the response module 130 detects multiple IVR speech recognition phrases 205 that are associated with conflicting IVR speech recognition values, the response module 130 may make a determination 510 based on the first IVR speech recognition phrase 205 that is received. Alternatively, the response module 130 may make the determination 510 based on an average of the IVR speech recognition values.

In one embodiment, the response module 130 determines 510 that the IVR system does not support IVR speech recognition in response to an activation command 225. The activation command 225 may be selected from the group consisting of a gesture command, a spoken command, a touch command, and a motion command. If the communication device 120 receives the activation command 225, the response module 130 may determine 510 that the IVR system does not support IVR speech recognition.

If the IVR system 110 supports speech recognition, the method 500 ends. If the IVR system 110 does not support speech recognition, the device speech recognition module 125 may prompt 515 for converting the specified spoken alphanumeric value 215. Prompting 515 for converting the specified spoken alphanumeric value 215 may comprise displaying a prompt asking the user if the specified spoken alphanumeric values 215 should be converted into telephonic keypad tone values. For example, the prompt “Convert Keypad Values?” may be displayed. Alternatively, the prompt “Activate Speech Conversion?” may be displayed.

The device speech recognition module 125 may determine 520 if converting the specified spoken alphanumeric value 215 is activated. In one embodiment, the device speech recognition module 125 determines 520 that converting the specified spoken alphanumeric value 215 is activated if the user responds with an affirmative indication in response to the prompt 515 for converting the specified spoken alphanumeric value 215. For example, the user may respond with one or more activation commands 225.

In an alternative embodiment, the device speech recognition module 125 determines 520 that converting the specified spoken alphanumeric value 215 is activated in response to a setting for the communication device 120. For example, the setting may specify that converting the specified spoken alphanumeric value 215 is activated in response to communicating with an IVR system 110 that does not support IVR speech recognition. In addition, the setting may specify that converting the specified spoken alphanumeric value 215 is activated when communicating with the IVR system 110 that does not support IVR speech recognition.

In one embodiment, the device speech recognition module 125 determines 520 that converting the specified spoken alphanumeric value 215 is activated in response to receiving an activation command 225. For example, a camera of the communication device 120 may detect a motion activation command 225 and determine 520 that IVR speech conversion is activated.

If converting the specified spoken alphanumeric value 215 is not activated, the device speech recognition module 125 may disable 535 the device speech recognition function. As a result, no spoken alphanumeric values 215 are converted into telephonic keypad tone values. If converting the specified spoken alphanumeric value 215 is activated, the device speech recognition module 125 may enable 525 the device speech recognition function. As a result, the device speech recognition module 125 may convert 530 the spoken alphanumeric values 215 into telephonic keypad tone values as will be described in FIGS. 6-7 and the method 500 ends.

FIG. 6 is a schematic flow chart diagram illustrating one embodiment of a spoken alphanumeric value conversion method 600. The method 600 may perform the convert spoken alphanumeric value step 530 described for FIG. 4. The method 600 may be performed by the processor 305. Alternatively, the method 600 may be performed by computer readable storage medium such as the memory 310. The computer readable storage media may store code that is executed by the processor 305 to perform the method 600. The computer readable storage medium may be embodied in a program product.

The method 600 starts, and in one embodiment, the communication device 120 receives 605 speech from the user. For example, the user may speak into a mobile telephone communication device 120. The device speech recognition module 125 may determine 610 if the speech includes the specified spoken alphanumeric value 215.

If the speech does not include the specified spoken alphanumeric value 215, the method 600 may end. If the speech includes the specified spoken alphanumeric value 215 the device speech recognition module 125 may convert 615 the specified spoken alphanumeric value 215 into one or more telephonic keypad tone values and the method 600 ends. For example, the device speech recognition module 125 may convert 615 the specified spoken alphanumeric value 215 of “1” into the telephonic keypad tone values for “1.”

FIG. 7 is a schematic flow chart diagram illustrating one alternate embodiment of a spoken alphanumeric value conversion method 650. The method 650 may perform the convert spoken alphanumeric value step 530 described for FIG. 4. The method 650 may be performed by the processor 305. Alternatively, the method 650 may be performed by computer readable storage medium such as the memory 310. The computer readable storage media may store code that is executed by the processor 305 to perform the method 650. The computer readable storage medium may be embodied in a program product.

The method 650 starts, and in one embodiment, the communication device 120 receives 655 speech from the user. For example, the user may speak into a mobile telephone communication device 120. The device speech recognition module 125 may determine 660 if the speech includes a preface phrase 210. For example, the device speech recognition module 125 may determine 660 if the speech includes the preface phrase 210 “Press.”

If the speech does not include a preface phrase 210, the method 650 ends. If the speech includes a preface phrase 210, the device speech recognition module 125 determines 665 if the speech includes a specified spoken alphanumeric value 215. In one embodiment, the device speech recognition module 125 determines 665 if the specified spoken alphanumeric value 215 follows the preface phrase 210. The specified spoken alphanumeric value 215 may follow the preface phrase 210 if the specified spoken alphanumeric value 215 follows within a preface time interval of 0.5 to 1.5 seconds.

If the speech does not include the specified spoken alphanumeric value 215 or if the specified spoken alphanumeric value 215 does not follow the preface phrase 210, the method 650 may end. If the speech includes the specified spoken alphanumeric value 215 or if the speech includes the specified spoken alphanumeric value 215 and the specified spoken alphanumeric value 215 follows the preface phrase 210, the device speech recognition module 125 may convert 670 the specified spoken alphanumeric value 215 into one or more telephonic keypad tone values corresponding to the spoken alphanumeric value 215 and the method 650 ends. For example, the device speech recognition module 125 may convert 615 the specified spoken alphanumeric value 215 of “1” into the telephonic keypad tone value for “1.”

The embodiments may convert a specified spoken alphanumeric value 215 into a telephonic keypad tone value at the communication device. In addition, the embodiments may determine that the communication device 120 is in communication with the IVR system 110 that does not support IVR speech recognition. As a result, the embodiments convert the spoken alphanumeric value 215 into telephonic keypad tone value that corresponds to the spoken alphanumeric value 215. As a result, the user is able to communicate telephonic keypad tone values without using the telephonic keypad 135, even when the IVR system 110 does not support IVR speech recognition.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a communication device;
a processor; and
a memory that stores code executable by the processor, the code comprising code that converts a specified spoken alphanumeric value into a telephonic keypad tone value at the communication device.

2. The apparatus of claim 1, wherein the code converts the specified spoken alphanumeric value into the telephonic keypad tone value in response to determining that the communication device is in communication with an interactive voice response (IVR) system that does not support IVR speech recognition.

3. The apparatus of claim 2, wherein the code determines that the IVR system does not support IVR speech recognition in response to one or more of detecting an IVR speech recognition phrase and detecting an activation command selected from the group consisting of a gesture command, a spoken command, a touch command, and a motion command.

4. The apparatus of claim 1, wherein the specified spoken alphanumeric value is one or more of an integer in the range of 0-9, a star, and a pound sign.

5. The apparatus of claim 1, wherein the specified spoken alphanumeric value is a letter.

6. The apparatus of claim 1, wherein the spoken alphanumeric value is identified by a preface phrase.

7. The apparatus of claim 1, the code further comprising code that:
prompts for converting the specified spoken alphanumeric value; and
enables converting the specified spoken alphanumeric value in response to an activation command.

8. A method comprising:
converting, by use of a processor, a specified spoken alphanumeric value into a telephonic keypad tone value at a communication device.

9. The method of claim 8, the method converting the specified spoken alphanumeric value into the telephonic keypad tone value in response to determining that the communication device is in communication with an interactive voice response (IVR) system that does not support IVR speech recognition.

10. The method of claim 9, the method determining that the IVR system does not support IVR speech recognition in response to one or more of detecting an IVR speech recognition phrase and detecting an activation command selected from the group consisting of a gesture command, a spoken command, a touch command, and a motion command.

11. The method of claim 8, wherein the specified spoken alphanumeric value is one or more of an integer in the range of 0-9, a star, and a pound sign.

12. The method of claim 8, wherein the specified spoken alphanumeric value is a letter.

13. The method of claim 8, wherein the spoken alphanumeric value is identified by a preface phrase.

14. The method of claim 8, the method further comprising:
prompting for converting the specified spoken alphanumeric value; and
enabling converting the specified spoken alphanumeric value in response to an activation command.

15. A program product comprising a computer readable storage medium that stores code executable by a processor to perform:
converting a specified spoken alphanumeric value into a telephonic keypad tone value at a communication device.

16. The program product of claim 15, wherein the code converts the specified spoken alphanumeric value into the telephonic keypad tone value in response to determining that the communication device is in communication with an interactive voice response (IVR) system that does not support IVR speech recognition.

17. The program product of claim 15, wherein the code determines that the IVR system does not support IVR speech recognition in response to one or more of detecting an IVR speech recognition phrase and detecting an activation command selected from the group consisting of a gesture command, a spoken command, a touch command, and a motion command.

18. The program product of claim 15, wherein the specified spoken alphanumeric value is one or more of an integer in the range of 0-9, a star, and a pound sign.

19. The program product of claim 15, wherein the specified spoken alphanumeric value is a letter.

20. The program product of claim 15, wherein the spoken alphanumeric value is identified by a preface phrase.
